(19) United States
(12) Patent Application Publication
(10) Pub. No.: US 2018/0329616 A1
(43) Pub. Date: Nov. 15, 2018

(54) ADAPTIVE METADATA FILTERS

(71) Applicant: Microsoft Technology Licensing, LLC, Redmond, WA (US)

(72) Inventors: Benjamin N. Truelove, Lynnwood, WA (US); John Lincoln DeMaris, Seattle, WA (US); Melissa Torres, Kirkland, WA (US); Yimin Wu, Redmond, WA (US); Hannah Misenar, Seattle, WA (US)

(21) Appl. No.: 15/594,146

(22) Filed: May 12, 2017

(51) Int. Cl. G06F 3/0484; G06F 17/30

(52) U.S. Cl. CPC G06F 3/04847; G06Q 30/0226; G06F 2203/04803; G06F 17/30011

(57) ABSTRACT

Among other things, embodiments of the present disclosure help improve the functionality of electronic document management software and systems by generating customized filter options to enhance the search criteria available to users in finding documents in the document management system. In some embodiments, the system may analyze metadata for an electronic document to identify interactions between users of the document management system and the document, and generate filter options based on such metadata that can be used to find and filter documents having various characteristics

### BACKGROUND

Document management systems allow users to create, edit, and share electronic documents. Some document management systems may contain large repositories of electronic documents, presenting challenges to users seeking to find particular documents or documents with particular characteristics. Embodiments of the present disclosure address these and other issues.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating an exemplary system according to various aspects of the disclosure;

FIG. 2 illustrates a flowchart of an exemplary method according to various aspects of the disclosure;

FIGS. 3-4 are exemplary screenshots according to various aspects of the disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Among other things, embodiments of the present disclosure help improve the functionality of electronic document management software and systems by generating customized filter options to enhance the search criteria available to users in finding documents in the document management system. In some embodiments, the system may analyze metadata for an electronic document to identify interactions between users of the document management system and the document, and generate filter options based on such metadata that can be used to find and filter documents having various characteristics.

Embodiments of the present disclosure described herein may be implemented using any combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Embodiments of the present disclosure may include, or may operate in conjunction with, various logic, components, modules, and mechanisms. Such components may include any combination of hardware, software, or firmware communicatively coupled to one or more processors in order to carry out the operations described herein. Components may be hardware components, and as such components may be considered tangible entities capable of performing specified operations and may be configured or arranged in a certain manner. For example, circuits may be arranged (e.g., internally or with respect to external entities such as other circuits) in a specified manner as a component. The whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine-readable medium.

In some exemplary embodiments, software, when executed by the underlying hardware of the component, causes the hardware to perform the specified operations. Accordingly, the term hardware component is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the modules need not be instantiated at any one moment in time. For example, where the components comprise a general-purpose hardware processor configured using software; the general-purpose hardware processor may be configured as respective different components at different times. Software may accordingly configure a hardware processor, for example, to constitute a particular component at one instance of time and to constitute a different component at a different instance of time. Components may also be software or firmware components, which operate to perform the methodologies described herein.

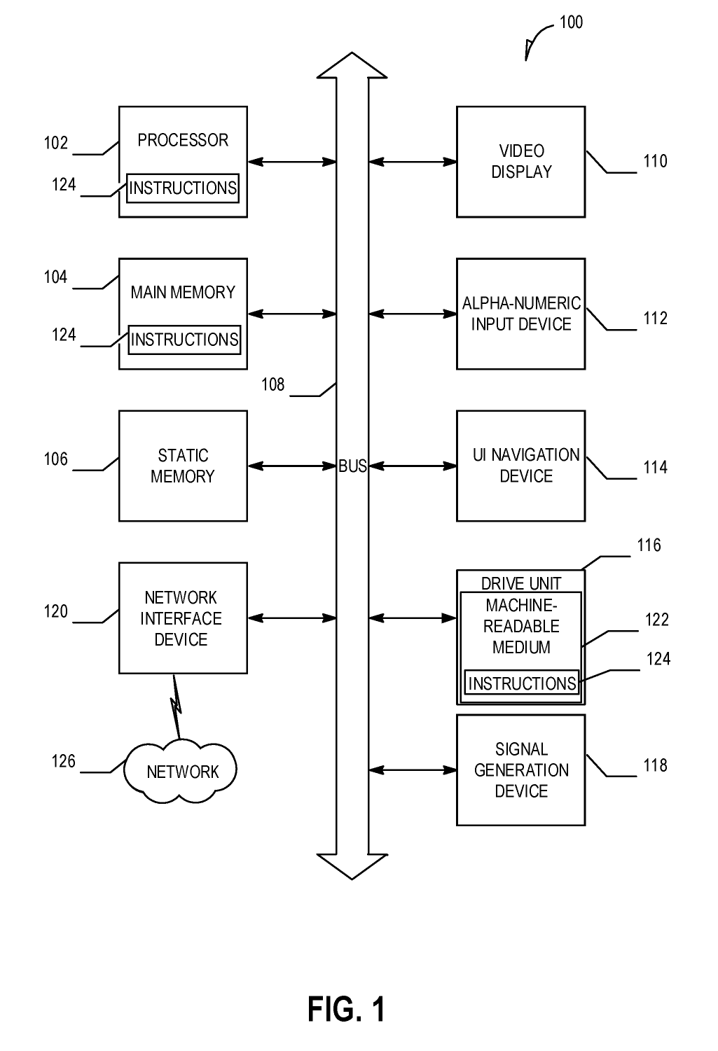

FIG. 1 is a block diagram illustrating an exemplary embodiment of a computer system 100, within which a set or sequence of instructions may be executed to cause the system to perform any of the functionality discussed herein. In some exemplary embodiments, the system 100 may operate as a standalone device or may be connected (e.g., networked) to other machines. In a networked deployment, the system may operate in the capacity of either a server or a client system in server-client network environments, or it may act as a peer machine in peer-to-peer (or distributed) network environments. The system may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine.

While only a single computer system is illustrated in FIG. 1, the terms “system,” “machine,” or “device” may include any collection of systems, machines, or devices that individually or jointly perform various functionality of the embodiments of the present disclosure. Similarly, the term “processor-based system” may include any set of one or more machines that are controlled by or operated by a processor (e.g., a computer) to individually or jointly execute instructions to perform any one or more of the methodologies discussed herein.

The exemplary computer system 100 in FIG. 1 includes a processor 102 (e.g., a central processing unit (CPU), a graphics processing unit (GPU) or both, processor cores, compute nodes, etc.), a main memory 104 and a static memory 106, which communicate with each other via a link 108 (e.g., bus). The computer system 100 may further include a video display unit 110, an alphanumeric input device 112 (e.g., a keyboard), and a user interface (UI) navigation device 114 (e.g., a mouse). In one embodiment, the video display unit 110, input device 112 and UI navigation device 114 are incorporated into a touch screen display. The computer system 100 may additionally include a storage device 116 (e.g., a drive unit), a signal generation device 118 (e.g., a speaker), a network interface device 120, and one or more sensors (not shown), such as a global positioning system (GPS) sensor, compass, accelerometer, or other sensor.

The storage device 116 includes a machine-readable medium 122 on which is stored one or more sets of data structures and instructions 124 (e.g., software) embodying or utilized by any one or more of the methodologies or functions described herein. The instructions 124 may also reside, completely or at least partially, within the main memory 104, static memory 106, and/or within the processor 102 during execution thereof by the computer system 100, with the main memory 104, static memory 106, and the processor 102 also constituting machine-readable media.

While the machine-readable medium 122 is illustrated to be a single medium, the term “machine-readable medium” may include a single medium or multiple media (e.g., a centralized or distributed database, and/or associated caches and servers) that store the one or more instructions 124. The term “machine-readable medium” may include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” may include, for example, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 124 may be transmitted or received over a communications network 126 using a transmission medium via the network interface device 120 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

In various exemplary embodiments of the present disclosure, filters may be used to narrow down a set of items in a repository to a set of items that match a particular set of criteria. For example, when browsing a SharePoint document library, users can use filters associated with column headings to filter documents by their value in the associated column. Additionally, embodiments of the disclosure can provide smart filter suggestions based on the shape of the data a user is currently looking at.

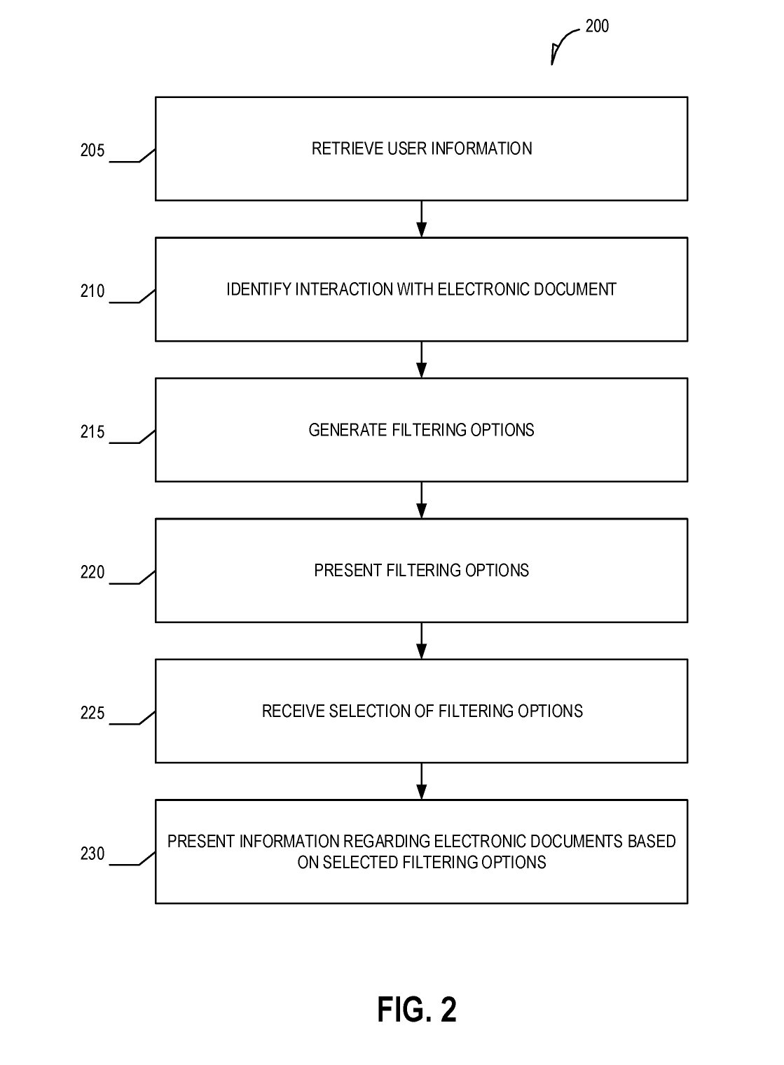

FIG. 2 depicts an exemplary process according to various aspects of the present disclosure. In this example, method 200 includes retrieving information associated with a user of an electronic document management system (205), identifying an interaction between the user of the electronic document management system and an electronic document (210), generate filtering options based on the identified interaction (215), and presenting the generated filtering options (220). Method 200 further includes receiving a selection of the filtering options (225) and presenting information regarding electronic documents based on the selected filtering options (230). The steps of method 200 may be performed in whole or in part, may be performed in conjunction each other as well as with some or all of the steps in other methods, and may be performed by any number of different systems, such as the system described in FIG. 1.

Embodiments of the present disclosure can retrieve (205) a variety of information regarding any number of different users of a document management system. The document management system (e.g., Sharepoint by Microsoft Corporation) may be implemented by the system (in whole or in part) by the system(s) performing the functionality of method 200, as well as by any combination of other systems and devices (e.g., in communication with each other via a network such as the Internet). Embodiments of the present disclosure may also operate in conjunction with content published by other types of software applications and systems, such as social media systems. In some exemplary embodiments, the system may retrieve (205) information such as the user's name or user identifier, organizations to which the user belongs, the user's title or role in such organizations, and documents within the document management system the user interacts with (e.g., accesses, modifies, saves, etc.).

The system may identify interactions (210) between users of the document management system and various documents in the document management system based on, for example, metadata stored with each respective document. For example, the system may analyze documents in the document management system to identify when a document was last modified, the user that performed the modification, other users associated with the document, a library or other repository within the document management system associated with the document, and other information.

The system may identify (210) a variety of different interactions between users of the document management system and various documents, such as accessing a document (e.g., opening the document, selecting the document to obtain information about the document, etc.), modifying the document (e.g., creating or deleting a document as well as adding, removing, or changing content within an existing document), and saving the document.

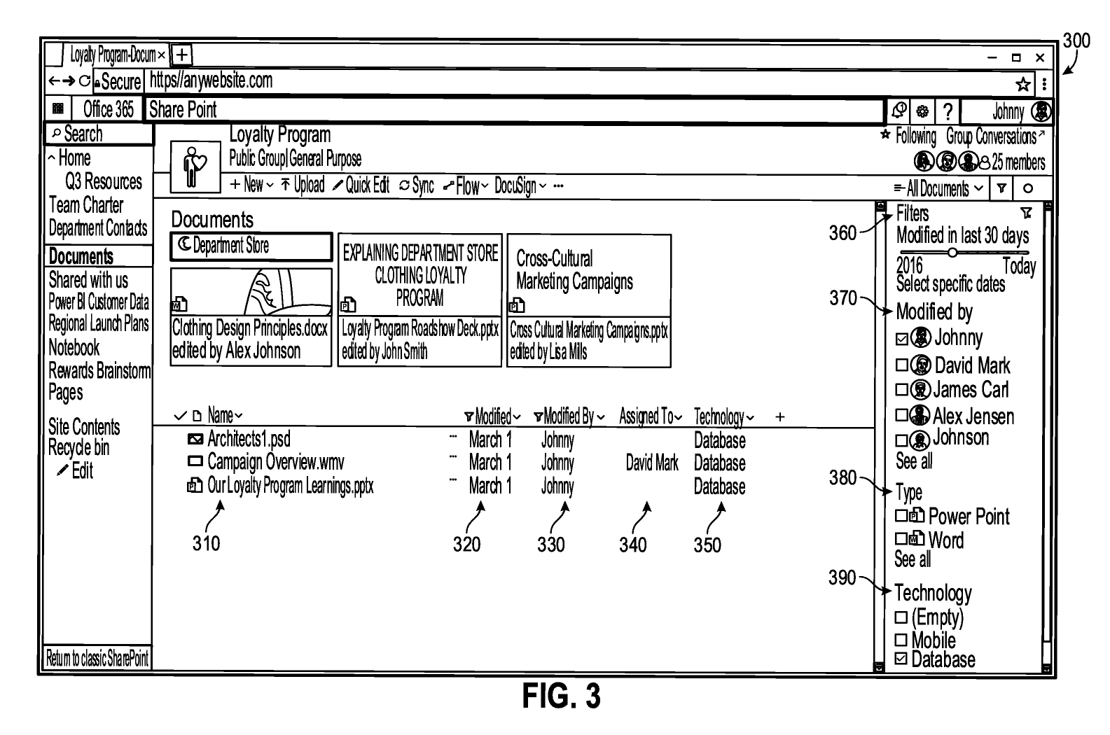

The system may generate (215) any number of different filtering options based on the interactions between one or more users with one or more documents, as well as based on other criteria. As used herein, the terms “filtering options,” “filter options,” or “filter values” refers generally to any criteria a user may select to filter a view or search of documents in the document management system. For example, in FIG. 3, filter options 370 show five separate filter values (“Johnny,” “David Mark,” etc.) for filtering the documents shown in the main window based on who modified the documents.

In some exemplary embodiments, the system generates filtering options by identifying a metadata field within an electronic document and generating a filtering option based on information in the metadata field. Such metadata fields may have data entered by a user of the electronic document management system, such as tags identifying that the document belongs to a particular project, for example. Metadata fields may also include as data entered automatically by the document management system, such as information on who last modified a document and when, as well as identifying characteristics of the document determined by the system from content within the document.

In some embodiments, the system may generate filtering options based on a plurality of interactions between a single user of the electronic document management system and a single document or multiple documents in the system. Similarly, filtering options may be generated based on a plurality of interactions between multiple users of the electronic document management system and a single document, or multiple users and multiple documents.

The filtering options may also be generated based on a document's location, format, or other characteristics. For example, filtering options may be generated based on the library or other repository containing a particular document. In cases where multiple documents are contained within a plurality of different libraries, filtering options may be generated for each respective library to allow a search to focus on selected libraries.

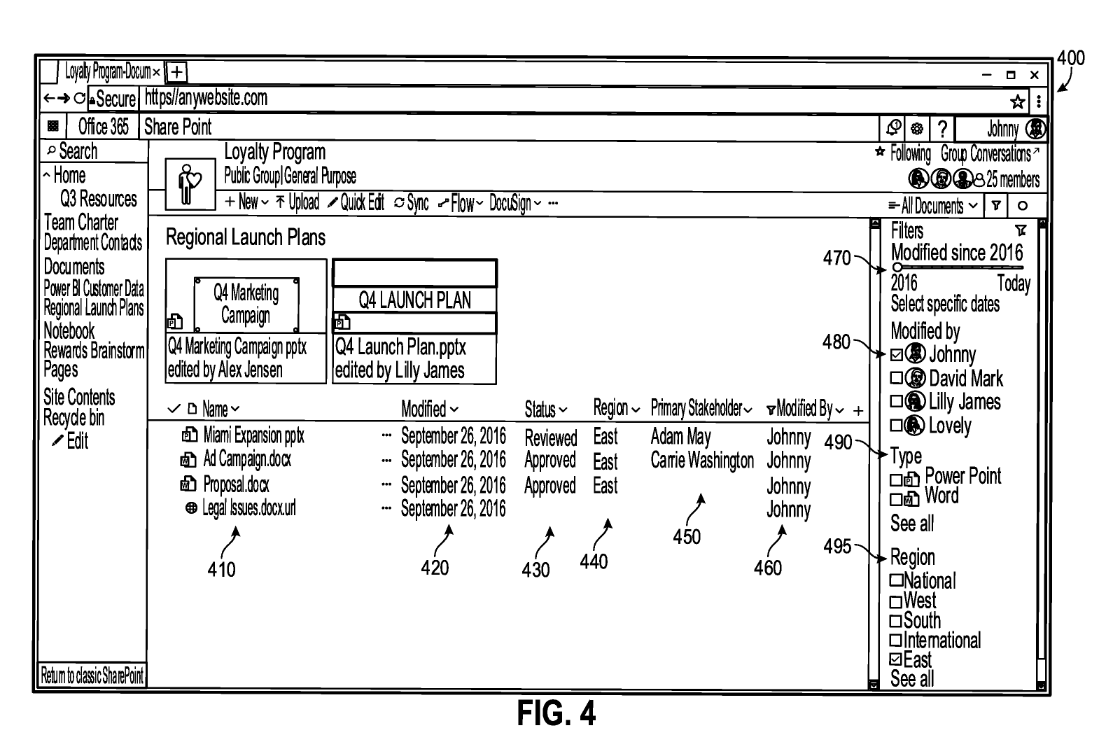

The system may generate filter options based on the libraries or repositories where the user is currently working, or repositories that contain similar content. During the course of work, the user might tag the items he's working on with metadata values, or type sentences or words inside documents that match metadata values that are used inside the repository for classification. Updating, saving, or “writing” particularly metadata values into a first document may coincide with a need to find other related documents in the repository that are classified with these same metadata values. Accordingly, when a user enters a browsing or searching experience in that repository, or a related repository, the system may generate filters that include those values that the user previously used in his/her own work. Moreover, the system may prioritize the ordering of such filter options to be presented ahead of other filter options that may be determined to be less relevant. Relevance of a filter option for purposes of ordering in the filter options pane (e.g., as shown in FIGS. 3 and 4) may vary based on the user, as well as the current state of the documents in the document management system and the interaction between the user (as well as other users) with the documents.

In some embodiments, various heuristics may be used to rank filter options for presentation to the user. For example, the system may prioritize filters that best divide the current working set. Likewise, the system may prioritize filters have been most frequently clicked by other users.

Filtering options may be generated based on connections between users of the electronic document management system. For example, the system may identify connections between a plurality of users who are part of the same organization (e.g., part of the same company). Such connections may include, for example, a first user who reports to a second user, users that share a common management chain (e.g., teams of members under a common manager), users who are part of a common subgroup within the organization (e.g., a division within the company, a team within the division, etc.), a first user who is a peer of a second user (e.g., users that have the same grade level or rank within the company), and users who exchange communications (e.g., emails, texts, phone calls, voicemails, etc.) with each other.

In some exemplary embodiments, the filtering options may be generated based on characteristics of the interaction between a user and a document. For example, a filtering option may be generated based on a number of interactions between a user and the document. The filtering option may be generated based on the total number of interactions between a user (or multiple users) and the document, or based on the number of interactions over a predetermined time period (e.g., one week, one month, etc.). Likewise, filtering options may be generated based on the amount of time a user (or users) spend interacting with a document, as well as when a document was last modified.

In some embodiments, a document management system employed in collaborative environments (e.g., where people are working together on a set of files, using metadata to classify files and keep them organized) the system may generate and display filters that help users find sets of documents/files most likely to be relevant to that particular user. For example, when a user is browsing a set of content and using filters to find a particular item, the filters presented to the user can be initially constructed by examining metadata associated with the documents in the document management system and personalized filters generated based on work that user has done in the past. For example, if a user frequently adds metadata tags to files with “Midwest US” in the “Region” column because the user is a sales manager for the Midwest US region, the system may generate filter options to filter items by North America. In another example, if a user frequently works with “Jane” in the Alberta sales region, then the system may generate filter options to show documents associated with the Alberta region.

In method 200 shown in FIG. 2, the system presents filtering options (220) via a display screen coupled to the system, receives selection of one or more filtering options from a user of the system (225), and presents information regarding one or more electronic documents (230) based on the selected filtering options.

FIGS. 3 and 4 depict exemplary screenshots of windows showing an interface to a document management system (e.g., Sharepoint Web by Microsoft Corporation). In these examples, filter options (360-390 in FIG. 3 and 470-495 in FIG. 4) are displayed in a first pane on the right of the screen, while information regarding electronic documents in the document management system (e.g., filtered based on the filter options selected by the user in the first pane) is displayed in the main pane of the window to the left of the filter options pane.

In some cases, particularly when browsing the contents of a large repository where items are classified using metadata, filters are useful for narrowing down to a smaller set of items, but large repositories that contain items with a lot of metadata, may result in a large number of filters being generated by the system. This can make presenting the best filters to a user to allow the user to find the documents most likely to be relevant to him/her a challenge.

Accordingly, in some exemplary embodiments, different filtering options may be ordered (e.g., based on the interactions between users and documents) and presented in the filter options pane based on the determined ordering. Filter options (as well as specific filter values for a filter option) may be ordered based on the most recent interactions between users of the document management system and one or more electronic documents. The filters may be used by users of the system to narrow down a set of items in a repository to a set of items that match a particular set of criteria. Users may, when browsing a document library, use filters associated with column headings to filter documents by their value in the associated column. In FIGS. 3 and 4, for example, a user may wish to only view documents in particular formats (e.g., PDF, MS Word, etc.), as well as to only show items last modified by a particular user (e.g., “Johnny” in FIG. 3).

Additionally, the system may generate filter options for the user (displayed in the right-hand panes of FIGS. 3 and 4) based on how the user (or other users) previously interacted with the documents in the document management system. In the example of the window 300 shown in FIG. 3, the filter pane includes options for filtering documents based on the columns (310, 320, 330, 340, 350) in the main pane. For example, the filters pane includes a slide control 360 to filter documents based on when they were last modified (e.g., modified within the last 30 days in this example), a set of checkboxes for filtering by users modifying the documents 370, file type/format 380, and technology area 390 (filtering based on files associated with the “Database” technology in this example). Filter options for other characteristics, such as to whom a file is assigned (column 340) may also be generated.

As noted above, the filter options may be generated based on metadata in documents within the document management system. In FIGS. 3 and 4, for example, the system may inspect the files/documents displayed in the main pane of the window, and generate filter options values that are represented across the set of displayed items. For example, in the example shown in FIG. 3, the system determines that “Johnny,” “David Mark,” “James Carl,” “Alex Jensen” and “Johnson” are each common authors of the three files displayed in the main window, and displays these user names as filter values for the “modified by” filter option 370.

Similarly, as shown in FIG. 4, the filtering pane, window 400 displays files that are filtered based on being modified since 2016 (field 470), and modified by “Johnny” (field 480). In this example, “Region=East” appears for 3 out of four of the items. In some embodiments, the system may determine that Johnny frequently uses “East” as a metadata value on his items, and determine that he will also want to use it as a filter, since it's common for users to want to find related files to the ones they have worked on in the past. Accordingly, the system may reorder the “Region” filter values 495 such that “East” the first filter value that's shown under the Region field 495 when Johnny is viewing the page. This evaluation might be different for another user based on the work they've done.

In some embodiments, users may manually add, remove, and order (e.g., via drag and drop) filter options within the filter pane themselves. Additionally or alternatively, the system may order the filter options based on a determined priority as described above. The ordering of filter options may be performed according to any desired weighting of the filter options, and such weighting may vary across different users.

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

Where a phrase similar to “at least one of A, B, or C,” “at least one of A, B, and C,” “one or more A, B, or C,” or “one or more of A, B, and C” is used herein, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Changes and modifications may be made to the disclosed embodiments without departing from the scope of the present disclosure. These and other changes or modifications are intended to be included within the scope of the present disclosure, as expressed in the following claims.

What is claimed is:

1. A system comprising:
a processor;
a user interface coupled to the processor, the user interface including a display screen and an input device; and
memory coupled to the processor and storing instructions that, when executed by the processor, cause the system to perform operations comprising:
retrieving information associated with a user of an electronic document management system;
identifying an interaction between the user of the electronic document management system and an electronic document in the electronic document management system;
generating, based on the interaction between the user and the electronic document, one or more electronic document filtering options;
presenting, on the display screen, the one or more electronic document filtering options; and
in response to a selection of a filtering option from the one or more electronic document filtering options by a user of the system via the input device, presenting, on the display screen, information regarding one or more electronic documents in the electronic document management system in accordance with the selected filtering option.

2. The system of claim 1, wherein the interaction between the user of the electronic document management system and the electronic document includes one or more of: accessing the electronic document, modifying the electronic document, and saving the electronic document.

3. The system of claim 1, wherein generating the one or more electronic document filtering options includes identifying a metadata field within the electronic document and generating a filtering option based on the identified metadata field.

4. The system of claim 3, wherein the identified metadata field includes data entered by the user of the electronic document management system.

5. The system of claim 3, wherein the identified metadata field includes data entered automatically by the electronic document management system.

6. The system of claim 1, wherein the one or more electronic document filtering options are generated based on a plurality of interactions between the user of the electronic document management system and a plurality of documents in the electronic document management system.

7. The system of claim 6, wherein the plurality of documents are contained within a plurality of libraries in the electronic document management system.

8. The system of claim 1, wherein the one or more electronic document filtering options are generated based on a plurality of interactions between a plurality of users of the electronic document management system and a plurality of documents in the electronic document management system.

9. The system of claim 8, wherein the plurality of users of the electronic document management system are identified based on connections between the plurality of users in an organization.

10. The system of claim 9, wherein the connections between the plurality of users in the organization include one or more of: a first user reporting to a second user, the plurality of users having a common management chain, the plurality of users being part of a common subgroup within the organization, a first user being a peer of a second user, and a first user exchanging a communication with a second user.

11. The system of claim 1, wherein the filtering options are presented in a first pane of a window on the display screen, and wherein the information regarding the one or more electronic documents is presented in a second pane of the window.

12. The system of claim 1, wherein generating the one or more filtering options is based on a number of interactions between the user of the electronic document management system and the electronic document.

13. The system of claim 12, wherein generating the one or more filtering options is based on a number of interactions between the user of the electronic document management system and the electronic document over a predetermined time period.

14. The system of claim 1, wherein generating the one or more filtering options is based on an amount of time spent by the user of the electronic document management system interacting with the electronic document.

15. The system of claim 1, wherein the system generates a plurality of filtering options, and wherein presenting the filtering options includes:
determining an order for the plurality of filtering options based on the interaction between the user of the electronic document management system and the electronic document; and
presenting the filtering options according to the determined order.

16. The system of claim 15, wherein the order for the plurality of filtering options is determined based on a most recent interaction between the user of the electronic document management system and the electronic document from a plurality of interactions between the user of the electronic document management system and the electronic document.

17. A computer-implemented method comprising:
retrieving, by a computer system, information associated with a user of an electronic document management system;
identifying, by the computer system, an interaction between the user of the electronic document management system and an electronic document in the electronic document management system;
generating, by the computer system and based on the interaction between the user and the electronic document, one or more electronic document filtering options;
presenting, by the computer system on a display screen coupled to the computer system, the one or more electronic document filtering options; and
in response to a selection of a filtering option from the one or more electronic document filtering options by a user of the computer system via an input device coupled to the computer system, presenting, by the computer system on the display screen, information regarding one or more electronic documents in the electronic document management system in accordance with the selected filtering option.

18. The method of claim 17, wherein the interaction between the user of the electronic document management system and the electronic document includes one or more of: accessing the electronic document, modifying the electronic document, and saving the electronic document.

19. A non-transitory computer-readable medium storing instructions that, when executed by a computer system, cause the computer system to perform operations comprising:
retrieving information associated with a user of an electronic document management system;
identifying an interaction between the user of the electronic document management system and an electronic document in the electronic document management system;
generating, based on the interaction between the user and the electronic document, one or more electronic document filtering options;
presenting, on a display screen coupled to the computer system, the one or more electronic document filtering options; and
in response to a selection of a filtering option from the one or more electronic document filtering options by a user of the computer system via an input device coupled to the computer system, presenting, on the display screen, information regarding one or more electronic documents in the electronic document management system in accordance with the selected filtering option.

20. The non-transitory computer-readable medium of claim 19, wherein the interaction between the user of the electronic document management system and the electronic document includes one or more of: accessing the electronic document, modifying the electronic document, and saving the electronic document.
